(19) United States
(12) Patent Application Publication
(10) Pub. No.: US 2025/0323588 A1
(43) Pub. Date: Oct. 16, 2025

(54) DRIVER CIRCUIT FOR SWITCHING CIRCUIT AND DRIVING CIRCUIT FOR MOTOR

(71) Applicant: Monolithic Power Systems, Inc., Kirkland, WA (US)

(72) Inventor: Chao-Han Lee, New Taipei City (TW)

(21) Appl. No.: 18/637,140

(22) Filed: Apr. 16, 2024

(51) Int. Cl. H02P 7/24; H02P 4/00

(52) U.S. Cl. CPC H02P 7/24; H02P 4/00

(57) ABSTRACT

A driver circuit for a switching circuit is provided. The driver circuit includes a PWM terminal, first to fourth gate control terminals configured to provide first to fourth control signals, a first output terminal, and a second output terminal. In a normal operation mode, during a first period of a first cycle, the first control signal and the fourth control signal are of a first voltage level, and during a second period of the first cycle, the second control signal and the fourth control signal are of the first voltage level. In a power loss mode, during the first period of the first cycle, the second control signal and the third control signal are of the first voltage level, and during the second period of the first cycle, the second control signal and the fourth control signal are of the first voltage level.

### TECHNICAL FIELD

The present disclosure relates to an electronic circuit. More particularly, the present disclosure relates to a driver circuit for a switching circuit and a driving circuit for a motor.

### BACKGROUND OF THE INVENTION

In a computer system, such as a desktop or notebook system, a main power source provides power to the main processing unit and other periphery devices of the system. When the main power source is plugged out during the operation, a backup battery will be activated to provide power to the computer system to backup data immediately. Meanwhile, the fan of the system keeps operating to dissipate heat generated by the main processing unit while saving the data. It is desirable to prolong the operation time of the fan to prolong the time for backup data when the main power source stops providing power or the main power source is plugged out.

### SUMMARY OF THE INVENTION

According to an embodiment of the present disclosure, a driver circuit for a switching circuit is provided. The switching circuit is configured to drive a motor. The driver circuit includes a pulse width modulation (PWM) terminal configured to receive a PWM signal, a first gate control terminal configured to provide a first control signal, a second gate control terminal configured to provide a second control signal, a third gate control terminal configured to provide a third control signal, a fourth gate control terminal configured to provide a fourth control signal, a first output terminal coupled to a first terminal of the motor, and a second output terminal coupled to a second terminal of the motor. A first cycle has a first period and a second period, the PWM signal is at a high logic level during the first period, and the PWM signal is at a low logic level during the second period. In a normal operation mode, during the first period of the first cycle, the first control signal and the fourth control signal are of a first voltage level and the second control signal and the third control signal are of a second voltage level, and during the second period of the first cycle, the second control signal and the fourth control signal are of the first voltage level and the first control signal and the third control signal are of the second voltage level. In a power loss mode, during the first period of the first cycle, the second control signal and the third control signal are of the first voltage level and the first control signal and the fourth control signal are of the second voltage level, and during the second period of the first cycle, the second control signal and the fourth control signal are of the first voltage level and the first control signal and the third control signal are of the second voltage level.

According to another embodiment of the present disclosure, a driving circuit for a motor is provided. The driving circuit includes a first switch, a second switch, a third switch, a fourth switch, a driving control circuit, a first output terminal, and a second output terminal. The first switch has a first terminal, a second terminal, and a control terminal. The first terminal of the first switch is configured to receive an input voltage. The second switch has a first terminal, a second terminal, and a control terminal. The first terminal of the second switch is coupled to the second terminal of the first switch, and the second terminal of the second switch is configured to be coupled to a ground. The third switch has a first terminal, a second terminal, and a control terminal. The first terminal of the third switch is configured to receive the input voltage. The fourth switch has a first terminal, a second terminal, and a control terminal. The first terminal of the fourth switch is coupled to the second terminal of the third switch, and the second terminal of the fourth switch is configured to be coupled to the ground. The driving control circuit is configured to provide, in response to a PWM signal, a first control signal to the control terminal of the first switch, a second control signal to the control terminal of the second switch, a third control signal to the control terminal of the third switch, and a fourth control signal to the control terminal of the fourth switch. The first output terminal is coupled to the second terminal of the first switch, the first terminal of the second switch, and a first terminal of the motor. The second output terminal is coupled to the second terminal of the third switch, the first terminal of the fourth switch, and a second terminal of the motor. A first cycle has a first period and a second period, the PWM signal is at a high logic level during the first period, and the PWM signal is at a low logic level during the second period. In a normal operation mode, during the first period of the first cycle, the first switch and the fourth switch are turned on, and during the second period of the first cycle, the second switch and the fourth switch are turned on. In a power loss mode, during the first period of the first cycle, the second switch and the third switch are turned on, and during the second period of the first cycle, the second switch and the fourth switch are turned on.

According to another embodiment of the present disclosure, a driving circuit for a motor is provided. The driving circuit includes a first switch and a second switch coupled in series, a third switch and a fourth switch coupled in series, a driving control circuit, a first output terminal, and a second output terminal. The driving control circuit is configured to control the first switch, the second switch, the third switch, and the fourth switch in response to a PWM signal. The first output terminal is configured to couple a common node of the first switch and the second switch to a first terminal of the motor. The second output terminal is configured to couple a common node of the third switch and the fourth switch to a second terminal of the motor. During a first cycle having a first period and a second period, a first current flows from the first output terminal to the second output terminal. In a normal operation mode, during the first period of the first cycle, a voltage at the first output terminal is of a first voltage level and a voltage at the second output terminal is of a second voltage level, and during the second period of the first cycle, the voltage at the first output terminal and the voltage at the second output terminal are of the second voltage level. In a power loss mode, during the first period of the first cycle, the voltage at the first output terminal is of the second voltage level and the voltage at the second output terminal is of the first voltage level, and during the second period of the first cycle, the voltage at the first output terminal and the voltage at the second output terminal are of the second voltage level.

### BRIEF DESCRIPTION OF THE DRAWINGS

The present disclosure can be further understood with reference to following detailed description and appended drawings, wherein like elements are provided with like reference numerals. These drawings are only for illustration purpose, thus may only show part of the devices and are not necessarily drawn to scale.

FIG. 1 is a schematic diagram of a power supply architecture for a computing device application.

FIG. 2 is a schematic diagram of a driver circuit for a switching circuit to drive a motor in accordance with an embodiment of the present disclosure.

FIG. 3 is a schematic diagram of a driving circuit for a motor in accordance with an embodiment of the present disclosure.

FIG. 4 is a schematic waveform diagram for signals of the driver circuit as shown in FIG. 2 operating in a positive half cycle in accordance with an embodiment of the present disclosure.

FIG. 5A is a schematic diagram illustrating the working principle of an H-bridge circuit to drive the motor during a period of the positive half cycle in the normal operation mode.

FIG. 5B is a schematic diagram illustrating the working principle of an H-bridge circuit to drive the motor during a period of the positive half cycle in the normal operation mode.

FIG. 6A is a schematic diagram illustrating the working principle of an H-bridge circuit to drive the motor during a period of the positive half cycle in the power loss mode.

FIG. 6B is a schematic diagram illustrating the working principle of an H-bridge circuit to drive the motor during a period of the positive half cycle in the power loss mode.

FIG. 7 is a schematic waveform diagram for signals of the driver circuit as shown in FIG. 2 operating in a negative half cycle in accordance with an embodiment of the present disclosure.

FIG. 8A is a schematic diagram illustrating the working principle of an H-bridge circuit to drive the motor during a period of the negative half cycle in the normal operation mode.

FIG. 8B is a schematic diagram illustrating the working principle of an H-bridge circuit to drive the motor during a period of the negative half cycle in the normal operation mode.

FIG. 9A is a schematic diagram illustrating the working principle of an H-bridge circuit to drive the motor during a period of the negative half cycle in the power loss mode.

FIG. 9B is a schematic diagram illustrating the working principle of an H-bridge circuit to drive the motor during a period of the negative half cycle in the power loss mode.

FIG. 10 is a schematic diagram of a driver circuit for a switching circuit in accordance with another embodiment of the present disclosure.

FIG. 11 is a schematic diagram of a driving circuit for a motor in accordance with another embodiment of the present disclosure.

FIG. 12 is a waveform diagram for signals of the driver circuit as shown in FIG. 10 operating in a first cycle in accordance with an embodiment of the present disclosure.

FIG. 13A is a schematic diagram illustrating the working principle of a bridge circuit to drive the motor during a period of the first cycle in the normal operation mode.

FIG. 13B is a schematic diagram illustrating the working principle of a bridge circuit to drive the motor during a period of the first cycle in the normal operation mode.

FIG. 14A is a schematic diagram illustrating the working principle of a bridge circuit to drive the motor during a period of the first cycle in the power loss mode.

FIG. 14B is a schematic diagram illustrating the working principle of a bridge circuit to drive the motor during a period of the first cycle in the power loss mode.

FIG. 15 is a schematic waveform diagram for signals of the driver circuit as shown in FIG. 10 operating in a second cycle in accordance with an embodiment of the present disclosure.

FIG. 16A is a schematic diagram illustrating the working principle of a bridge circuit to drive the motor during a period of the second cycle in the normal operation mode.

FIG. 16B is a schematic diagram illustrating the working principle of a bridge circuit to drive the motor during a period of the second cycle in the normal operation mode.

FIG. 17A is a schematic diagram illustrating the working principle of a bridge circuit to drive the motor during a period of the second cycle in the power loss mode.

FIG. 17B is a schematic diagram illustrating the working principle of a bridge circuit to drive the motor during a period of the second cycle in the power loss mode.

The use of the same reference label in different drawings indicates the same or like components.

### DETAILED DESCRIPTION

Various embodiments of the present disclosure will now be described. In the following description, some specific details, such as example circuits and example values for these circuit components, are included to provide a thorough understanding of embodiments. One skilled in the relevant art will recognize, however, that the present disclosure can be practiced without one or more specific details, or with other methods, components, materials, etc. In other instances, well-known structures, materials, processes or operations are not shown or described in detail to avoid obscuring aspects of the present disclosure.

Throughout the specification and claims, the terms “left”, “right”, “in”, “out”, “front”, “back”, “up”, “down”, “top”, “atop”, “bottom”, “on”, “over”, “under”, “above”, “below”, “vertical” and the like, if any, are used for descriptive purposes and not necessarily for describing permanent relative positions. It is to be understood that the terms so used are interchangeable under appropriate circumstances such that embodiments of the technology described herein are, for example, capable of operation in other orientations than those illustrated or otherwise described herein. The phrases “in one embodiment”, “in some embodiments”, “in one implementation”, and “in some implementations” as used include both combinations and sub-combinations of various features described herein as well as variations and modifications thereof. These phrases used herein do not necessarily refer to the same embodiment, although they may. Those skilled in the art should understand that the meanings of the terms identified above do not necessarily limit the terms, but merely provide illustrative examples for the terms. It is noted that when an element is “connected to” or “coupled to” the other element, it means that the element is directly connected to or coupled to the other element, or that the element is indirectly connected to or coupled to the other element via another element. Particular features, structures or characteristics may be included in an integrated circuit, an electronic circuit, a combinational logic circuit, or other suitable components that provide the described functionality. In addition, it is appreciated that the figures provided herewith are for explanation purposes to persons ordinarily skilled in the art and that the drawings are not necessarily drawn to scale.

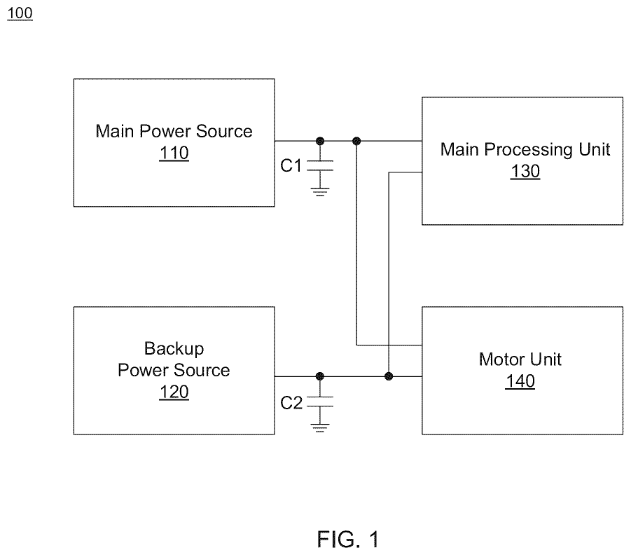

FIG. 1 is a schematic diagram 100 of a power supply architecture for a computing device application. The power supply architecture includes a main power source 110, a backup power source 120, and capacitors C1 and C2. The computing device includes a main processing unit 130 and a motor unit 140. In some embodiments, the computing device may include, but not limited to, a personal computer, a laptop, a smart phone, or other similar device. In some embodiments, the main processing unit 130 may include a central processing unit (CPU), a graphics processing unit (GPU), or other processing unit. In some embodiments, the motor unit 140 includes a motor and a motor driver. In some embodiments, the motor is a motor of a fan, and the motor driver is configured to drive the fan in order to dissipate heat generated by the main processing unit 130.

The main power source 110 coupled to the capacitor C1 is configured to provide power to the main processing unit 130 and the motor unit 140 during a normal operation of the power supply architecture. For example, the main power source 110 is configured to provide an input voltage or an input current to the main processing unit 130 and the motor unit 140. The backup power source 120 coupled to the capacitor C2 is configured to provide power to the main processing unit 130 and the motor unit 140 when the main power source 110 stops providing power or when the input voltage or input current of the computing device drops.

In some embodiments, when the main power source 110 stops providing power or the main power source 110 is plugged out, or the supply voltage or supply current from the main power source 110 drops, the computing device needs to back up the data in the main processing unit 130 immediately. This requires the backup power source 120 powers the main processing unit 130 and the motor unit 140. However, the backup power source 120 may run out of power before the data is completely saved. The motor driver that recycles the energy of the motor and store the energy back to the capacitor (e.g., C2) is provided in the present disclosure. Accordingly, the operation time of the main processing unit 130 and the motor unit 140 can be prolonged while the data is being saved.

For instance, when the main power source is plugged out, the fan enters in a power loss mode. Specifically, when the input current of the fan is lower than a value, or is equal to zero, the loss of main power source is detected, and the fan driver controls the fan to coast at a lower speed (e.g., rpm) to reduce the power consumption in the power loss mode. In one embodiment, in the power loss mode, the duty cycle of the PWM signal may be used by the fan driver to drive the fan at the lower target speed. In another embodiment, in the power loss mode, the frequency of the PWM signal is used to control the target speed of the fan or lower the power consumption. In the present disclosure, by changing the driving of the switching circuits, the mechanical energy of the fan is transferred back to charge the capacitor (e.g., C2) to prolong the power supply by the backup power source.

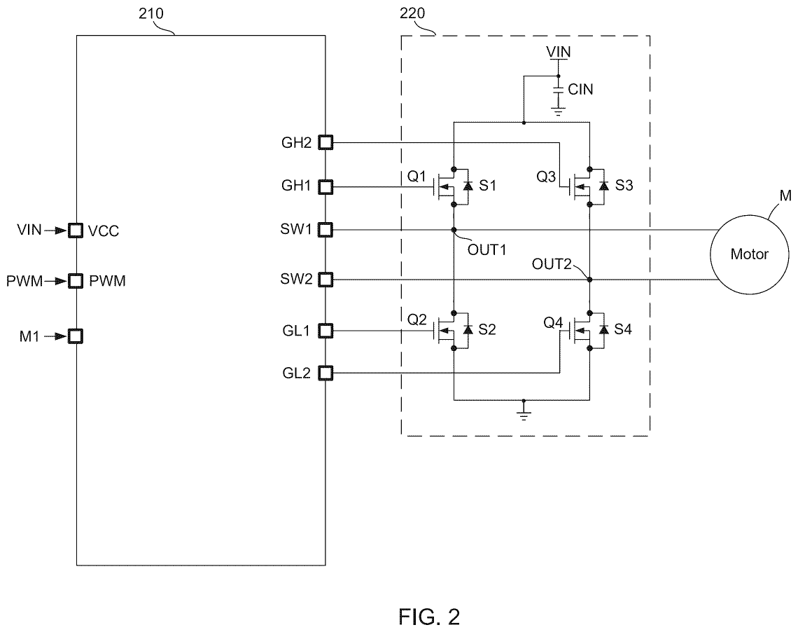

FIG. 2 is a schematic diagram of a driver circuit 210 for a switching circuit 220 to drive a motor M in accordance with an embodiment of the present disclosure. In some embodiments, the motor M is a single-phase motor (e.g., a motor fan), and the switching circuit 220 has an H-bridge configuration to provide power to the motor M. Specifically, the switching circuit 220 includes a first switch S1, a second switch S2, a third switch S3, and a fourth switch S4. The first switch S1 and the second switch S2 are coupled in series, and the third switch S3 and the fourth switch S4 are coupled in series. For instance, the first terminal of the first switch S1 is configured to receive an input voltage VIN. The first terminal of the second switch S2 is coupled to the second terminal of the first switch S1 at a node OUT1, and the second terminal of the second switch S2 is configured to be coupled to a ground. The first terminal of the third switch S3 is configured to receive the input voltage VIN. The first terminal of the fourth switch S4 is coupled to the second terminal of the third switch S3 at a node OUT2, and the second terminal of the fourth switch S4 is configured to be coupled to the ground. In one embodiment, the switching circuit 220 further includes an input capacitor CIN configured to filter the input voltage VIN.

In some embodiments, the node OUT1 of the switching circuit 220 is coupled to a first terminal of the motor M, and the node OUT2 of the switching circuit 220 is coupled to a second terminal of the motor M to drive the motor. The switching circuit 220 is configured to provide a current signal from the node OUT1 to the motor M, or from the node OUT2 to the motor M. In some embodiments, the motor has a rotor and a stator. The rotor has permanent magnets to form magnetic poles. The stator has windings wound along arms of the stator. The current flows through the stator windings and induces electromagnetic poles accordingly. The magnetic force generated by rotor magnetic field and stator electromagnetic field causes the rotor to rotate.

The driver circuit 210 is configured to control the switches in the switching circuit 220 to be turned on or off. The driver circuit 210 includes an input voltage terminal VCC, a pulse width modulation (PWM) terminal PWM, a first gate control terminal GH1, a second gate control terminal GL1, a third gate control terminal GH2, a fourth gate control terminal GL2, a first output terminal SW1, and a second output terminal SW2. The input voltage terminal VCC is configured to receive the input voltage VIN. The PWM terminal is configured to receive a PWM signal. The driver circuit 210 is configured to provide control signals to the switching circuit 220 in response to the PWM signal. Specifically, the first gate control terminal GH1 is configured to provide a first control signal Q1 to the control terminal of the first switch S1, the second gate control terminal GL1 is configured to provide a second control signal Q2 to the control terminal of the second switch S2, the third gate control terminal GH2 is configured to provide a third control signal Q3 to the control terminal of the third switch S3, and the fourth gate control terminal GL2 is configured to provide a fourth control signal Q4 to the control terminal of the fourth switch S4. The first output terminal SW1 is coupled to the node OUT1. The second output terminal SW2 is coupled to the node OUT2.

In one embodiment, the driver circuit 210 further includes a terminal configured to receive a signal M1. The signal M1 is indicative of a power loss command. For example, when the signal M1 transitions from a low logic level to a high logic level, a power loss command indicating that the main power source stops providing power is detected by the driver circuit 210. Accordingly, the driver circuit 210 operates into a power loss mode according to the power loss command. In another embodiment, the power loss command could be detected according to the PWM signal. For example, when the duty cycle of the PWM signal decreases to be lower than a threshold (e.g., <0.05) for a period of time (e.g., 2 ms), the power loss command is detected, and the driver circuit controls the motor to enter in lower power loss mode. In another embodiment, when the PWM signal is at a low logic level for a period of time (e.g., 2 ms), the power loss command is detected, and the driver circuit controls the motor to enter in lower power loss mode. In some embodiments, the power loss command is detected according to the frequency of the PWM signal. In some other embodiments, when the input current is lower than a value (e.g., <0.5 A) for a period of time (e.g., >0.5 ms), the power loss command is detected.

In some embodiments, the driver circuit 210 is an integrated circuit (IC), and the switching circuit 220 is an external circuit to the driver circuit 210. The input voltage terminal VCC, the PWM terminal PWM, the first gate control terminal GH1, the second gate control terminal GL1, the third gate control terminal GH2, the fourth gate control terminal GL2, the first output terminal SW1, and the second output terminal SW2 of the driver circuit 210 are pins of the IC.

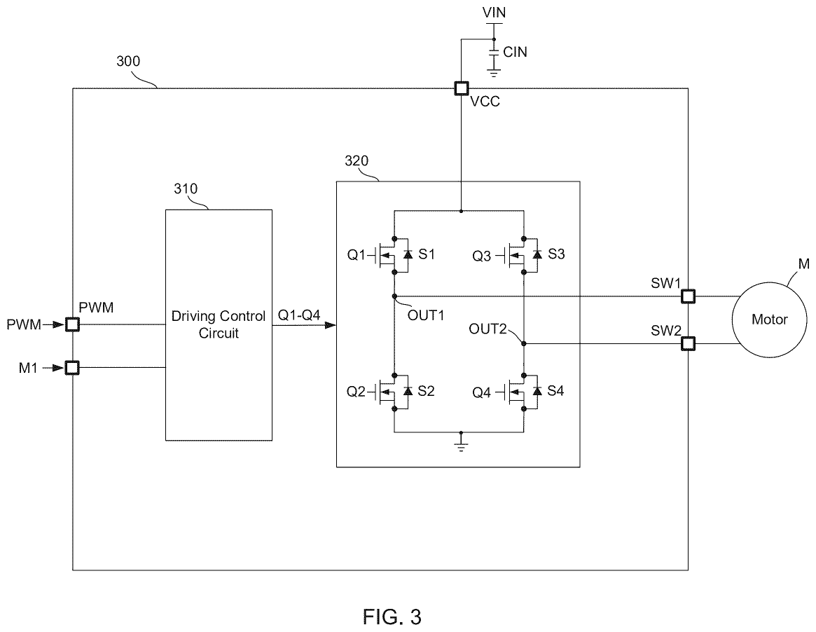

FIG. 3 is a schematic diagram of a driving circuit 300 for the motor M in accordance with an embodiment of the present disclosure. The driving circuit 300 includes a driving control circuit 310, a switching circuit 320, a first output terminal SW1, and a second output terminal SW2. The switching circuit 320 includes the first switch S1, the second switch S2, the third switch S3, and the fourth switch S4. The first switch S1 and the second switch S2 are coupled in series, and the third switch S3 and the fourth switch S4 are coupled in series. The first terminal of the first switch S1 is configured to receive an input voltage VIN. The first terminal of the second switch S2 is coupled to the second terminal of the first switch S1 at a node OUT1, and the second terminal of the second switch S2 is configured to be coupled to a ground. The first terminal of the third switch S3 is configured to receive the input voltage VIN. The first terminal of the fourth switch S4 is coupled to the second terminal of the third switch S3 at a node OUT2, and the second terminal of the fourth switch S4 is configured to be coupled to the ground.

In some embodiments, the first output terminal SW1 is coupled to the node OUT1 and the first terminal of the motor M, and the second output terminal SW2 is coupled to the node OUT2 and the second terminal of the motor M. The switching circuit 320 is configured to provide a current signal from the node OUT1 to the motor M, or from the node OUT2 to the motor M.

The driving control circuit 310 is configured to provide, in response to the PWM signal, the first control signal Q1 to the control terminal of the first switch S1, the second control signal Q2 to the control terminal of the second switch S2, the third control signal Q3 to the control terminal of the third switch S3, and the fourth control signal Q4 to the control terminal of the fourth switch S4.

In some embodiments, the driving circuit 300 further includes the input voltage terminal VCC configured to receive the input voltage VIN. In one embodiment, the input voltage terminal VCC is coupled to an input capacitor CIN configured to filter the input voltage VIN. In some embodiments, the driving circuit 300 further includes the PWM terminal configured to receive the PWM signal. In some embodiments, the driving circuit 300 further includes a terminal configured to receive the signal M1 indicative of the power loss command.

In some embodiments, the driving control circuit 310 and the switching circuit 320 are integrated into an IC, and the input voltage terminal VCC, the PWM terminal, the first output terminal SW1, and the second output terminal SW2 are pins of the IC.

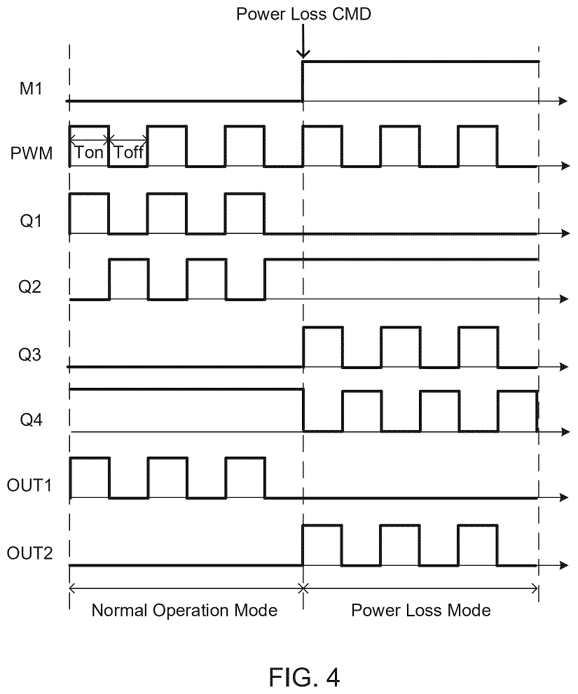

FIG. 4 is a schematic waveform diagram for signals of the driver circuit 210 as shown in FIG. 2 operating in a positive half cycle in accordance with an embodiment of the present disclosure. The waveforms of the signal M1, the PWM signal, the first control signal Q1, the second control signal Q2, the third control signal Q3, the fourth control signal Q4, the voltage at the node OUT1 (i.e., the voltage at the first output terminal SW1), and the voltage at the node OUT2 (i.e., the voltage at the second output terminal SW2) are illustrated in FIG. 4. The period Ton is indicative of the period when the PWM signal is at a high logic level, and the period Toff is indicative of the period when the PWM signal is at a low logic level.

In some embodiments, when the signal M1 is at a low logic level, the driver circuit 210 operates in the normal operation mode, and when the signal M1 transitions from the low logic level to a high logic level, the driver circuit 210 receives the power loss command and operates in the power loss mode.

As shown in FIG. 4, in the normal operation mode, during the period Ton of the positive half cycle, both the first control signal Q1 and the fourth control signal Q4 are at a high logic level, and both the second control signal Q2 and the third control signal Q3 are at a low logic level. In some embodiments, the switches S1-S4 are N-type metal-oxide-semiconductor field-effect transistors (NMOS). Accordingly, a high logic level corresponds to a high voltage level to turn on the NMOS, while a low logic level corresponds to a low voltage level to turn off the NMOS. In alternative embodiments, the switches S1-S4 are P-type metal-oxide-semiconductor field-effect transistors (PMOS). Accordingly, a high logic level corresponds to a low voltage level to turn on the PMOS, while a low logic level corresponds to a high voltage level to turn off the PMOS.

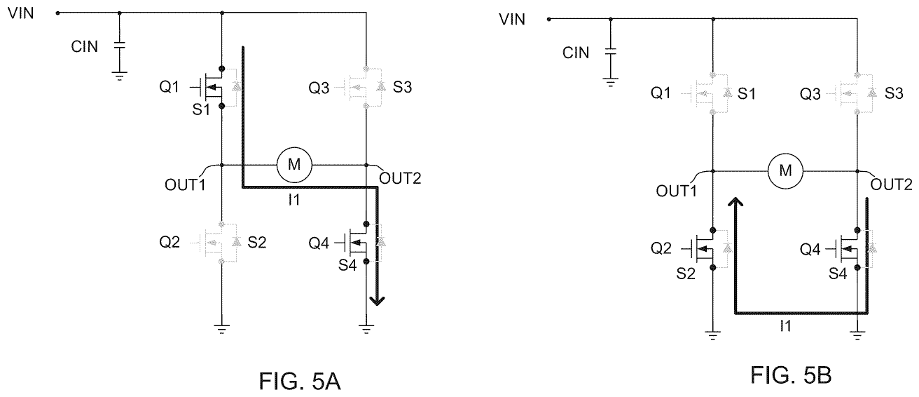

FIG. 5A is a schematic diagram illustrating the working principle of an H-bridge circuit to drive the motor M during the period Ton of the positive half cycle in the normal operation mode. During the positive half cycle, a current flows through the motor M from the node OUT1 to the node OUT2. During the period Ton of the positive half cycle, the first switch S1 and the fourth switch S4 are both turned on in response to the first control signal Q1 and the fourth control signal Q4 as shown in FIG. 4. The current I1 flowing through the first switch S1, flows from the node OUT1 to the node OUT2 through the motor M, and then flows to the fourth switch S4. Since the first switch S1 is turned on, the voltage at the node OUT1 is of a high voltage level (e.g., VIN), and the voltage at the node OUT2 is of a low voltage level (e.g., the ground voltage) since the fourth switch S4 is turned on.

As shown in FIG. 4, in the normal operation mode, during the period Toff of the positive half cycle, both the second control signal Q2 and the fourth control signal Q4 are at a high logic level, and both the first control signal Q1 and the third control signal Q3 are at a low logic level.

FIG. 5B is a schematic diagram illustrating the working principle of an H-bridge circuit to drive the motor M during the period Toff of the positive half cycle in the normal operation mode. During the period Toff of the positive half cycle, the second switch S2 and the fourth switch S4 are both turned on in response to the second control signal Q2 and the fourth control signal Q4 as shown in FIG. 4. The current I1 flowing through the fourth switch S4 and through the second switch S2, flows from the node OUT1 to the node OUT2 through the motor M. Since the second switch S2 and the fourth switch S4 are both turned on, the voltages at the nodes OUT1 and OUT2 are of a low voltage level (e.g., the ground voltage).

As shown in FIG. 4, in the power loss mode, during the period Ton of the positive half cycle, both the second control signal Q2 and the third control signal Q3 are at a high logic level, and both the first control signal Q1 and the fourth control signal Q4 are at a low logic level.

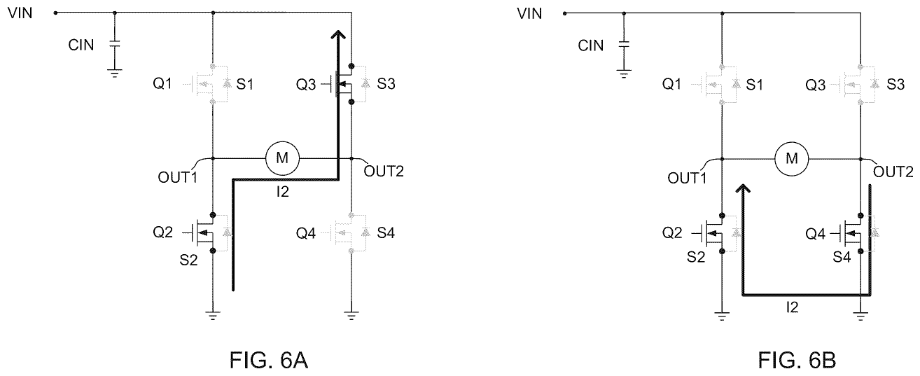

FIG. 6A is a schematic diagram illustrating the working principle of an H-bridge circuit to drive the motor M during the period Ton of the positive half cycle in the power loss mode. During the period Ton of the positive half cycle, the second switch S2 and the third switch S3 are both turned on in response to the second control signal Q2 and the third control signal Q3 as shown in FIG. 4. The current I2 flowing through the second switch S2, flows from the node OUT1 to the node OUT2 through the motor M, and through the third switch S3. Since the third switch S3 is turned on, the voltage at the node OUT2 is of a high voltage level (e.g., VIN), and the voltage at the node OUT1 is of a low voltage level (e.g., the ground voltage) since the second switch S2 is turned on.

Therefore, in the power loss mode, during the period Ton of the positive half cycle, the current I2 flows to the capacitor CIN and charges the capacitor CIN. In some embodiments, the energy stored in the capacitor CIN may be used to power the driver circuit 210 before the main power supply is restored.

As shown in FIG. 4, in the power loss mode, during the period Toff of the positive half cycle, both the second control signal Q2 and the fourth control signal Q4 are at a high logic level, and both the first control signal Q1 and the third control signal Q3 are at a low logic level.

FIG. 6B is a schematic diagram illustrating the working principle of an H-bridge circuit to drive the motor M during the period Toff of the positive half cycle in the power loss mode. During the period Toff of the positive half cycle, the second switch S2 and the fourth switch S4 are both turned on in response to the second control signal Q2 and the fourth control signal Q4 as shown in FIG. 4. The current I2 flowing through the fourth switch S4 and through the second switch S2, flows from the node OUT1 to the node OUT2 through the motor M. Since the second switch S2 and the fourth switch S4 are both turned on, the voltages at the nodes OUT1 and OUT2 are of a low voltage level (e.g., the ground voltage).

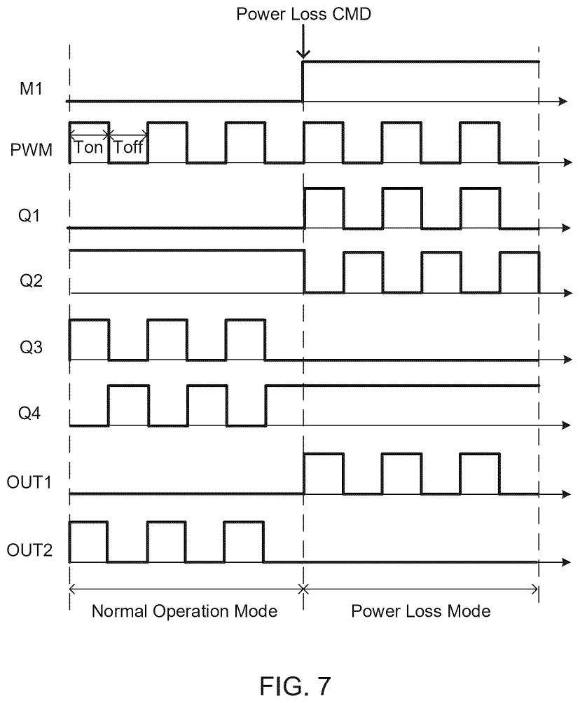

FIG. 7 is a schematic waveform diagram for signals of the driver circuit 210 as shown in FIG. 2 operating in a negative half cycle in accordance with an embodiment of the present disclosure. In some embodiments, the driver circuit 210 switches to operate in the power loss mode when the signal M1 transitions from a low logic level to a high logic level.

As shown in FIG. 7, in the normal operation mode, during the period Ton of the negative half cycle, both the second control signal Q2 and the third control signal Q3 are at a high logic level, and both the first control signal Q1 and the fourth control signal Q4 are at a low logic level.

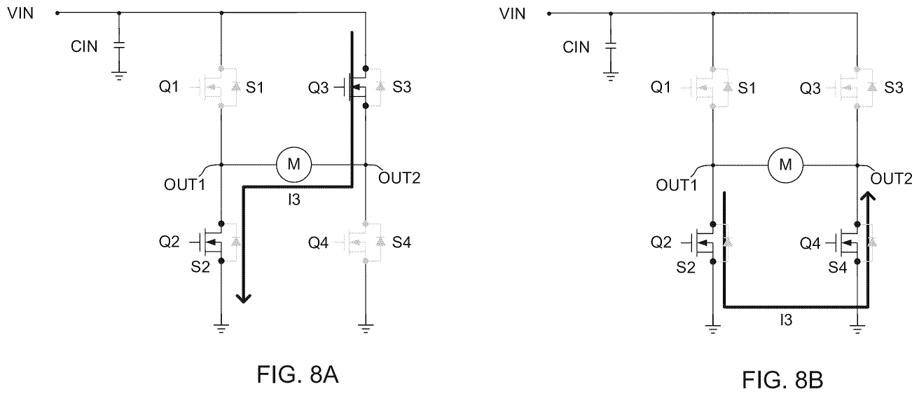

FIG. 8A is a schematic diagram illustrating the working principle of an H-bridge circuit to drive the motor M during the period Ton of the negative half cycle in the normal operation mode. During the negative half cycle, a current flows through the motor M from the node OUT2 to the node OUT1. During the period Ton of the negative half cycle, the second switch S2 and the third switch S3 are both turned on in response to the second control signal Q2 and the third control signal Q3 as shown in FIG. 7. The current I3 flowing through the third switch S3, flows from the node OUT2 to the node OUT1 through the motor M, and then flows to the second switch S2. Since the third switch S3 is turned on, the voltage at the node OUT2 is of a high voltage level (e.g., VIN), and the voltage at the node OUT1 is of a low voltage level (e.g., the ground voltage) since the second switch S2 is turned on.

As shown in FIG. 7, in the normal operation mode, during the period Toff of the negative half cycle, both the second control signal Q2 and the fourth control signal Q4 are at a high logic level, and both the first control signal Q1 and the third control signal Q3 are at a low logic level.

FIG. 8B is a schematic diagram illustrating the working principle of an H-bridge circuit to drive the motor M during the period Toff of the negative half cycle in the normal operation mode. During the period Toff of the negative half cycle, the second switch S2 and the fourth switch S4 are both turned on in response to the second control signal Q2 and the fourth control signal Q4 as shown in FIG. 7. The current I3 flowing through the second switch S2 and through the fourth switch S4, flows from the node OUT2 to the node OUT1 through the motor M. Since the second switch S2 and the fourth switch S4 are both turned on, the voltages at the nodes OUT1 and OUT2 are of a low voltage level (e.g., the ground voltage).

As shown in FIG. 7, in the power loss mode, during the period Ton of the negative half cycle, both the first control signal Q1 and the fourth control signal Q4 are at a high logic level, and both the second control signal Q2 and the third control signal Q3 are at a low logic level.

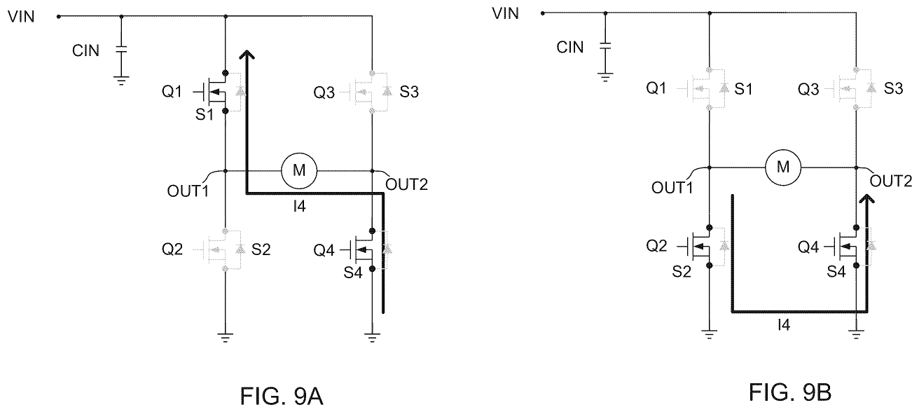

FIG. 9A is a schematic diagram illustrating the working principle of an H-bridge circuit to drive the motor M during the period Ton of the negative half cycle in the power loss mode. During the period Ton of the negative half cycle, the first switch S1 and the fourth switch S4 are both turned on in response to the first control signal Q1 and the fourth control signal Q4 as shown in FIG. 7. The current I4 flowing through the fourth switch S4, flows from the node OUT2 to the node OUT1 through the motor M, and through the first switch S1. Since the first switch S1 is turned on, the voltage at the node OUT1 is of a high voltage level (e.g., VIN), and the voltage at the node OUT2 is of a low voltage level (e.g., the ground voltage) since the fourth switch S4 is turned on.

Therefore, in the power loss mode, during the period Ton of the negative half cycle, the current I4 flows to the capacitor CIN and charges the capacitor CIN. In some embodiments, the energy stored in the capacitor CIN may be used to power the driver circuit 210 before the main power supply is restored.

As shown in FIG. 7, in the power loss mode, during the period Toff of the negative half cycle, both the second control signal Q2 and the fourth control signal Q4 are at a high logic level, and both the first control signal Q1 and the third control signal Q3 are at a low logic level.

FIG. 9B is a schematic diagram illustrating the working principle of an H-bridge circuit to drive the motor M during the period Toff of the negative half cycle in the power loss mode. During the period Toff of the negative half cycle, the second switch S2 and the fourth switch S4 are both turned on in response to the second control signal Q2 and the fourth control signal Q4 as shown in FIG. 7. The current I4 flowing through the second switch S2 and through the fourth switch S4, flows from the node OUT2 to the node OUT1 through the motor M. Since the second switch S2 and the fourth switch S4 are both turned on, the voltages at the nodes OUT1 and OUT2 are of a low voltage level (e.g., the ground voltage).

As discussed in the embodiment of FIG. 4, the driver circuit 210 enters into the power loss mode during the positive half cycle. In some embodiments, after operating during the positive half cycle, the driver circuit 210 continues to operate in the power loss mode during the negative half cycle, and the signals of the driver circuit 210 may have the waveforms as illustrated in FIG. 7. Similarly, as discussed in the embodiments of FIG. 7, the driver circuit 210 enters into the power loss mode during the negative half cycle. In some embodiments, after operating during the negative half cycle, the driver circuit 210 continues to operate in the power loss mode during the positive half cycle, and the signals of the driver circuit 210 may have the waveforms as illustrated in FIG. 4.

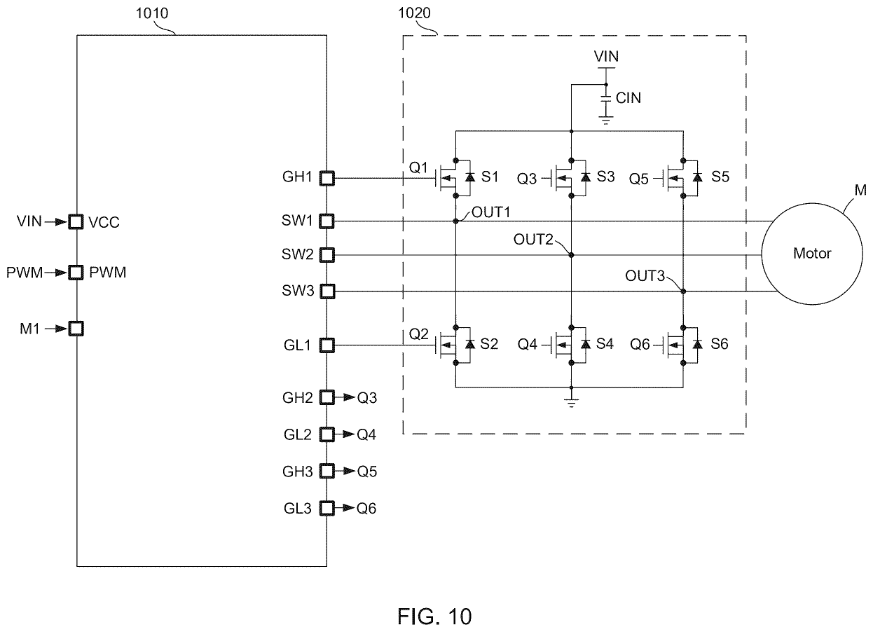

FIG. 10 is a schematic diagram of a driver circuit 1010 for a switching circuit 1020 in accordance with another embodiment of the present disclosure. In some embodiments, the motor M is a three-phase motor, and the switching circuit 1020 has a three-phase bridge configuration. In one embodiment, the switching circuit 1020 further includes a fifth switch S5 and a sixth switch S6 coupled in series. The first terminal of the fifth switch S5 is configured to receive the input voltage VIN. The first terminal of the sixth switch S6 is coupled to the second terminal of the fifth switch S5 at a node OUT3. The second terminal of the sixth switch S6 is configured to be coupled to the ground. The node OUT3 of the switching circuit 1020 is coupled to a third terminal of the motor M.

In one embodiment, the driver circuit 1010 further includes a fifth gate control terminal GH3, a sixth gate control gate terminal GL3, and a third output terminal SW3. The fifth gate control terminal GH3 is configured to provide a fifth control signal Q5 to the control terminal of the fifth switch S5. The sixth gate control gate terminal GL3 is configured to provide a sixth control signal Q6 to the control terminal of the sixth switch S6. The third output terminal SW3 is coupled to the node OUT3.

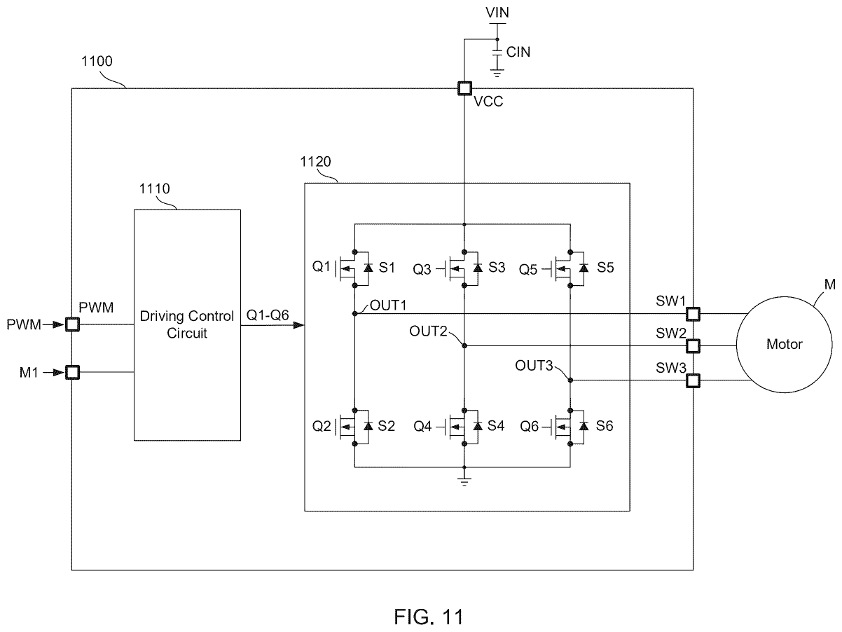

FIG. 11 is a schematic diagram of a driving circuit 1100 for the motor M in accordance with another embodiment of the present disclosure. In some embodiments, the motor M is a three-phase motor, and the switching circuit 1120 has a three-phase bridge configuration. In one embodiment, the switching circuit 1120 further includes the fifth switch S5 and the sixth switch S6, and the driving control circuit 1110 is further configured to provide the fifth control signal Q5 and the sixth control signal Q6 to the control terminals of the fifth switch S5 and the sixth switch S6 respectively, in response to the PWM signal. Also, the driving circuit 1100 further includes the third output terminal SW3 that is coupled to the node OUT3 and the third terminal of the motor M.

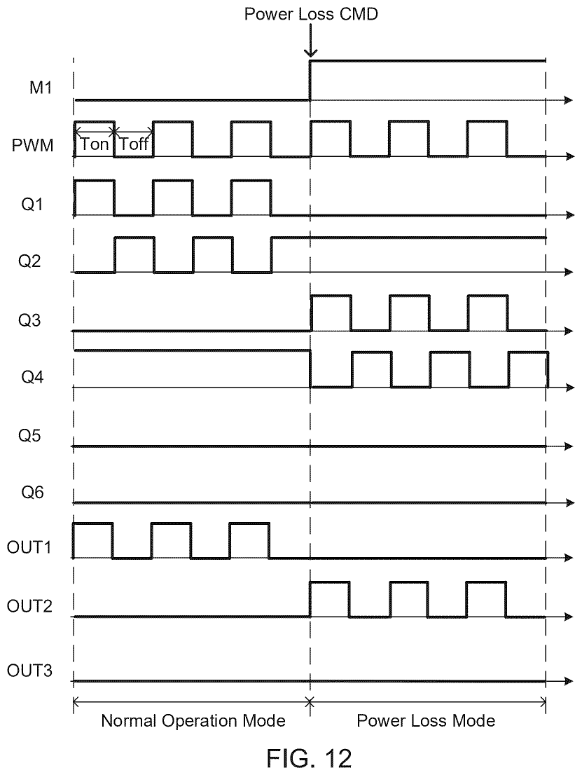

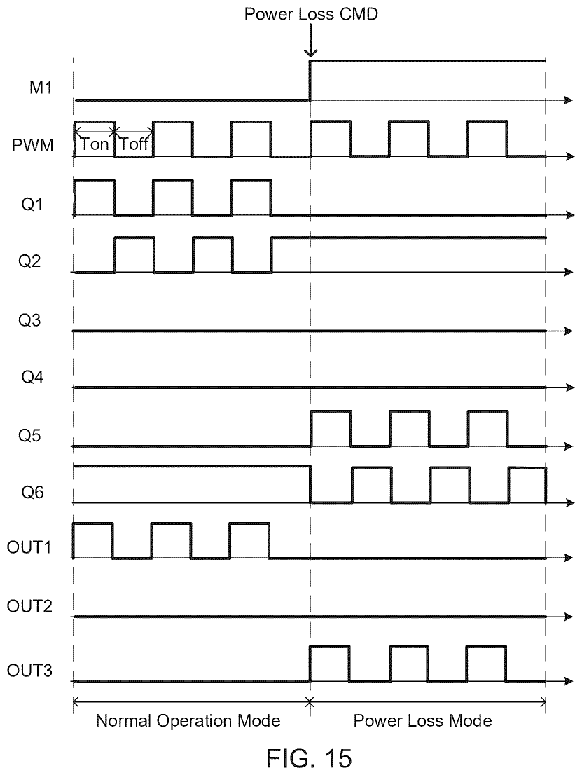

FIG. 12 is a waveform diagram for signals of the driver circuit 1010 as shown in FIG. 10 operating in a first cycle in accordance with an embodiment of the present disclosure. During the first cycle, a current flows through the motor M from the first output terminal SW1 to the second output terminal SW2 of the driver circuit 1010. In some embodiments, the driver circuit 1010 is configured to operate in different cycles other than the first cycle, for example, the second cycle as shown in FIG. 15. Persons having ordinary skill should be able to understand the operation of the driver circuit 1010 in other cycles according to the embodiments of the present disclosure.

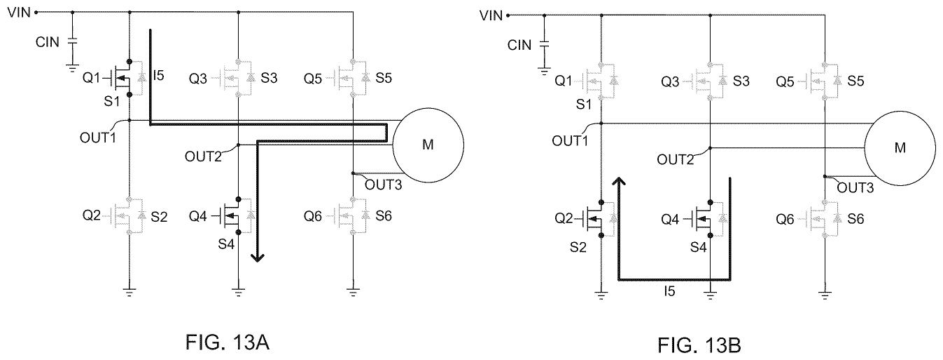

FIG. 13A is a schematic diagram illustrating the working principle of a bridge circuit to drive the motor M during the period Ton of the first cycle in the normal operation mode. During the period Ton of the first cycle, the first switch S1 and the fourth switch S4 are both turned on in response to the first control signal Q1 and the fourth control signal Q4 as shown in FIG. 12. The current I5 flowing through the first switch S1, flows from the node OUT1 to the node OUT2 through the motor M, and then flows to the fourth switch S4. Since the first switch S1 is turned on, the voltage at the node OUT1 is of a high voltage level (e.g., VIN), and the voltage at the node OUT2 is of a low voltage level (e.g., the ground voltage) since the fourth switch S4 is turned on.

FIG. 13B is a schematic diagram illustrating the working principle of a bridge circuit to drive the motor M during the period Toff of the first cycle in the normal operation mode. During the period Toff of the first cycle, the second switch S2 and the fourth switch S4 are both turned on in response to the second control signal Q2 and the fourth control signal Q4 as shown in FIG. 12. The current I5 flowing through the fourth switch S4 and through the second switch S2, flows from the node OUT1 to the node OUT2 through the motor M. Since the second switch S2 and the fourth switch S4 are both turned on, the voltages at the nodes OUT1 and OUT2 are of a low voltage level (e.g., the ground voltage).

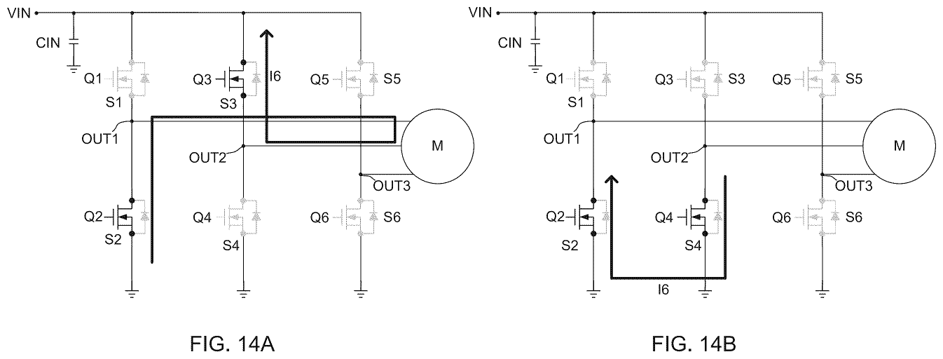

FIG. 14A is a schematic diagram illustrating the working principle of a bridge circuit to drive the motor M during the period Ton of the first cycle in the power loss mode. During the period Ton of the first cycle, the second switch S2 and the third switch S3 are both turned on in response to the second control signal Q2 and the third control signal Q3 as shown in FIG. 12. The current I6 flowing through the second switch S2, flows from the node OUT1 to the node OUT2 through the motor M, and through the third switch S3. Since the third switch S3 is turned on, the voltage at the node OUT2 is of a high voltage level (e.g., VIN), and the voltage at the node OUT1 is of a low voltage level (e.g., the ground voltage) since the second switch S2 is turned on.

FIG. 14B is a schematic diagram illustrating the working principle of a bridge circuit to drive the motor M during the period Toff of the first cycle in the power loss mode. During the period Toff of the first cycle, the second switch S2 and the fourth switch S4 are both turned on in response to the second control signal Q2 and the fourth control signal Q4 as shown in FIG. 12. The current I6 flowing through the fourth switch S4 and through the second switch S2, flows from the node OUT1 to the node OUT2 through the motor M. Since the second switch S2 and the fourth switch S4 are both turned on, the voltages at the nodes OUT1 and OUT2 are of a low voltage level (e.g., the ground voltage).

FIG. 15 is a schematic waveform diagram for signals of the driver circuit 1010 as shown in FIG. 10 operating in a second cycle in accordance with an embodiment of the present disclosure. During the second cycle, a current flows through the motor M from the first output terminal SW1 to the third output terminal SW3 of the driver circuit 1010.

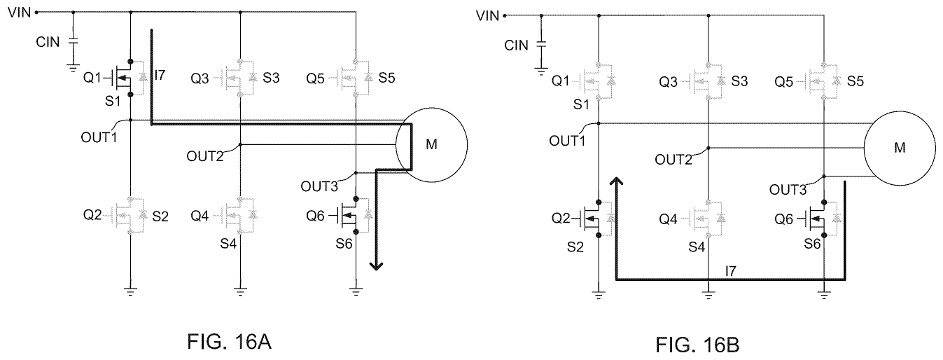

FIG. 16A is a schematic diagram illustrating the working principle of a bridge circuit to drive the motor M during the period Ton of the second cycle in the normal operation mode. During the period Ton of the second cycle, the first switch S1 and the sixth switch S6 are both turned on in response to the first control signal Q1 and the sixth control signal Q6 as shown in FIG. 15. The current I7 flowing through the first switch S1, flows from the node OUT1 to the node OUT3 through the motor M, and then flows to the sixth switch S6. Since the first switch S1 is turned on, the voltage at the node OUT1 is of a high voltage level (e.g., VIN), and the voltage at the node OUT3 is of a low voltage level (e.g., the ground voltage) since the sixth switch S6 is turned on.

FIG. 16B is a schematic diagram illustrating the working principle of a bridge circuit to drive the motor M during the period Toff of the second cycle in the normal operation mode. During the period Toff of the second cycle, the second switch S2 and the sixth switch S6 are both turned on in response to the second control signal Q2 and the sixth control signal Q6 as shown in FIG. 15. The current I7 flowing through the sixth switch S6 and through the second switch S2, flows from the node OUT1 to the node OUT3 through the motor M. Since the second switch S2 and the sixth switch S6 are both turned on, the voltages at the nodes OUT1 and OUT3 are of a low voltage level (e.g., the ground voltage).

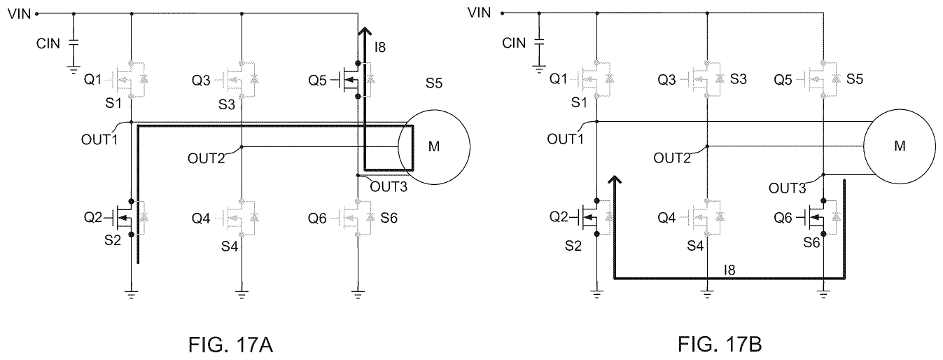

FIG. 17A is a schematic diagram illustrating the working principle of a bridge circuit to drive the motor M during the period Ton of the second cycle in the power loss mode. During the period Ton of the second cycle, the second switch S2 and the fifth switch S5 are both turned on in response to the second control signal Q2 and the fifth control signal Q5 as shown in FIG. 15. The current I8 flowing through the second switch S2, flows from the node OUT1 to the node OUT3 through the motor M, and through the fifth switch S5. Since the fifth switch S5 is turned on, the voltage at the node OUT3 is of a high voltage level (e.g., VIN), and the voltage at the node OUT1 is of a low voltage level (e.g., the ground voltage) since the second switch S2 is turned on.

FIG. 17B is a schematic diagram illustrating the working principle of a bridge circuit to drive the motor M during the period Toff of the second cycle in the power loss mode. During the period Toff of the second cycle, the second switch S2 and the sixth switch S6 are both turned on in response to the second control signal Q2 and the sixth switch S6 as shown in FIG. 15. The current I8 flowing through the sixth switch S6 and through the second switch S2, flows from the node OUT1 to the node OUT3 through the motor M. Since the second switch S2 and the sixth switch S6 are both turned on, the voltages at the nodes OUT1 and OUT3 are of a low voltage level (e.g., the ground voltage).

The present disclosure provides a driver circuit and a driving circuit that recycle the energy of the motor when operating in the power loss mode to prolong the operating time of the motor. Furthermore, for a laptop application that the battery life is important, when the main power source stops providing power, the energy may be used to backup data before the system shutdown.

While various embodiments have been described above to illustrate the switch circuit of the present disclosure, it should be understood that they have been presented by way of example only, and not limitation. Rather, the scope of the present disclosure is defined by the following claims and includes combinations and sub-combinations of the various features described above, as well as variations and modifications thereof, which would occur to persons skilled in the art upon reading the foregoing description.

What is claimed is:

1. A driver circuit for a switching circuit, wherein the switching circuit is configured to drive a motor, and the driver circuit comprises:
a pulse width modulation (PWM) terminal configured to receive a PWM signal;
a first gate control terminal configured to provide a first control signal;
a second gate control terminal configured to provide a second control signal;
a third gate control terminal configured to provide a third control signal;
a fourth gate control terminal configured to provide a fourth control signal;
a first output terminal coupled to a first terminal of the motor; and
a second output terminal coupled to a second terminal of the motor;
wherein a first cycle has a first period and a second period, the PWM signal is at a high logic level during the first period, and the PWM signal is at a low logic level during the second period;
wherein in a normal operation mode, during the first period of the first cycle, the first control signal and the fourth control signal are of a first voltage level and the second control signal and the third control signal are of a second voltage level, and during the second period of the first cycle, the second control signal and the fourth control signal are of the first voltage level and the first control signal and the third control signal are of the second voltage level;
wherein in a power loss mode, during the first period of the first cycle, the second control signal and the third control signal are of the first voltage level and the first control signal and the fourth control signal are of the second voltage level, and during the second period of the first cycle, the second control signal and the fourth control signal are of the first voltage level and the first control signal and the third control signal are of the second voltage level.

2. The driver circuit of claim 1, wherein in the normal operation mode, during the first period of the first cycle, a voltage at the first output terminal is of a third voltage level and a voltage at the second output terminal is of a fourth voltage level, and during the second period of the first cycle, the voltage at the first output terminal and the voltage at the second output terminal are of the fourth voltage level;
wherein in the power loss mode, during the first period of the first cycle, the voltage at the first output terminal is of the fourth voltage level and the voltage at the second output terminal is of the third voltage level, and during the second period of the first cycle, the voltage at the first output terminal and the voltage at the second output terminal are of the fourth voltage level.

3. The driver circuit of claim 1, wherein a second cycle has the first period and the second period;
wherein in the normal operation mode, during the first period of the second cycle, the second control signal and the third control signal are of the first voltage level, and during the second period of the second cycle, the second control signal and the fourth control signal are of the first voltage level;
wherein in the power loss mode, during the first period of the second cycle, the first control signal and the fourth control signal are of the first voltage level, during the second period of the second cycle, the second control signal and the fourth control signal are of the first voltage level.

4. The driver circuit of claim 3, wherein in the normal operation mode, during the first period of the second cycle, a voltage at the first output terminal is of a fourth voltage level and a voltage at the second output terminal is of a third voltage level, and during the second period of the second cycle, the voltage at the first output terminal and the voltage at the second output terminal are of the fourth voltage level;
wherein in the power loss mode, during the first period of the second cycle, the voltage at the first output terminal is of the third voltage level and the voltage at the second output terminal is of the fourth voltage level, and during the second period of the second cycle, the voltage at the first output terminal and the voltage at the second output terminal are of the fourth voltage level.

5. The driver circuit of claim 1, further comprising:
a fifth gate control terminal configured to provide a fifth control signal;
a sixth gate control terminal configured to provide a sixth control signal; and
a third output terminal coupled to a third terminal of the motor;
wherein a second cycle has the first period and the second period;
wherein in the normal operation mode, during the first period of the second cycle, the first control signal and the sixth control signal are of the first voltage level, and during the second period of the second cycle, the second control signal and the sixth control signal are of the first voltage level;
wherein in the power loss mode, during the first period of the second cycle, the second control signal and the fifth control signal are of the first voltage level, and during the second period of the second cycle, the second control signal and the sixth control signal are of the first voltage level.

6. The driver circuit of claim 5, wherein in the normal operation mode, during the first period of the second cycle, a voltage at the first output terminal is of a third voltage level and a voltage at the second output terminal and a voltage at the third output terminal are of a fourth voltage level, and during the second period of the second cycle, the voltage at the first output terminal, the voltage at the second output terminal, and the voltage at the third output terminal are of the fourth voltage level;
wherein in the power loss mode, during the first period of the second cycle, the voltage at the first output terminal and the voltage at the second output terminal are of the fourth voltage level and the voltage at the third output terminal is of the third voltage level, and during the second period of the second cycle, the voltage at the first output terminal, the voltage at the second output terminal, and the voltage at the third output terminal are of the fourth voltage level.

7. A driving circuit for a motor, the driving circuit comprising:
a first switch having a first terminal, a second terminal, and a control terminal, wherein the first terminal of the first switch is configured to receive an input voltage;
a second switch having a first terminal, a second terminal, and a control terminal, wherein the first terminal of the second switch is coupled to the second terminal of the first switch, and the second terminal of the second switch is configured to be coupled to a ground;
a third switch having a first terminal, a second terminal, and a control terminal, wherein the first terminal of the third switch is configured to receive the input voltage;
a fourth switch having a first terminal, a second terminal, and a control terminal, wherein the first terminal of the fourth switch is coupled to the second terminal of the third switch, and the second terminal of the fourth switch is configured to be coupled to the ground;
a driving control circuit configured to provide, in response to a PWM signal, a first control signal to the control terminal of the first switch, a second control signal to the control terminal of the second switch, a third control signal to the control terminal of the third switch, and a fourth control signal to the control terminal of the fourth switch;
a first output terminal coupled to the second terminal of the first switch, the first terminal of the second switch, and a first terminal of the motor; and
a second output terminal coupled to the second terminal of the third switch, the first terminal of the fourth switch, and a second terminal of the motor;
wherein a first cycle has a first period and a second period, the PWM signal is at a high logic level during the first period, and the PWM signal is at a low logic level during the second period;
wherein in a normal operation mode, during the first period of the first cycle, the first switch and the fourth switch are turned on, and during the second period of the first cycle, the second switch and the fourth switch are turned on;
wherein in a power loss mode, during the first period of the first cycle, the second switch and the third switch are turned on, and during the second period of the first cycle, the second switch and the fourth switch are turned on.

8. The driving circuit of claim 7, wherein in the power loss mode, during the first period of the first cycle, a current flowing through the second switch, flows from the first output terminal to the second output terminal through the motor, and through the third switch.

9. The driving circuit of claim 7, wherein in the power loss mode, during the second period of the first cycle, a current flowing through the fourth switch and through the second switch, flows from the first output terminal to the second output terminal through the motor.

10. The driving circuit of claim 7, wherein a second cycle has the first period and the second period;
wherein in the normal operation mode, during the first period of the second cycle, the second switch and the third switch are turned on, and during the second period of the second cycle, the second switch and the fourth switch are turned on;
wherein in the power loss mode, during the first period of the second cycle, the first switch and the fourth switch are turned on, during the second period of the second cycle, the second switch and the fourth switch are turned on.

11. The driving circuit of claim 10, wherein in the power loss mode, during the first period of the second cycle, a current flowing through the fourth switch, flows from the second output terminal to the first output terminal through the motor, and through the first switch.

12. The driving circuit of claim 10, wherein in the power loss mode, during the second period of the second cycle, a current flowing through the second switch and through the fourth switch, flows from the second output terminal to the first output terminal through the motor.

13. The driving circuit of claim 7, wherein the switching circuit further comprises:
a fifth switch having a first terminal, a second terminal, and a control terminal, wherein a first terminal of the fifth switch is configured to receive the input voltage;
a sixth switch having a first terminal, a second terminal, and a control terminal, wherein a first terminal of the sixth switch is coupled to the second terminal of the fifth switch, and a second terminal of the sixth switch is configured to be coupled to the ground; and
a third output terminal coupled to the second terminal of the fifth switch, the first terminal of the sixth switch, and a third terminal of the motor;
wherein the driving control circuit is further configured to provide, in response to the PWM signal, a fifth control signal to the control terminal of the fifth switch and a sixth control signal to the control terminal of the sixth switch;
wherein a second cycle has the first period and the second period;
wherein in the normal operation mode, during the first period of the second cycle, the first switch and the sixth switch are turned on, and during the second period of the second cycle, the second switch and the sixth switch are turned on.

14. The driving circuit of claim 13, wherein in the power loss mode, during the first period of the second cycle, the second switch and the fifth switch are turned on, and during the second period of the second cycle, the second switch and the sixth switch are turned on.

15. A driving circuit for a motor, the driving circuit comprising:
a first switch and a second switch coupled in series;
a third switch and a fourth switch coupled in series;
a driving control circuit configured to control the first switch, the second switch, the third switch, and the fourth switch in response to a PWM signal;
a first output terminal configured to couple a common node of the first switch and the second switch to a first terminal of the motor; and
a second output terminal configured to couple a common node of the third switch and the fourth switch to a second terminal of the motor;
wherein a first cycle has a first period and a second period, the PWM signal is at a high logic level during the first period, and the PWM signal is at a low logic level during the second period;
wherein in a normal operation mode, during the first period of the first cycle, a voltage at the first output terminal is of a first voltage level and a voltage at the second output terminal is of a second voltage level, and during the second period of the first cycle, the voltage at the first output terminal and the voltage at the second output terminal are of the second voltage level;
wherein in a power loss mode, during the first period of the first cycle, the voltage at the first output terminal is of the second voltage level and the voltage at the second output terminal is of the first voltage level, and during the second period of the first cycle, the voltage at the first output terminal and the voltage at the second output terminal are of the second voltage level.

16. The driving circuit of claim 15, wherein in the normal operation mode, during the first period of the first cycle, the first switch and the fourth switch are turned on, and during the second period of the first cycle, the second switch and the fourth switch are turned on;
wherein in the power loss mode, during the first period of the first cycle, the second switch and the third switch are turned on, and during the second period of the first cycle, the second switch and the fourth switch are turned on.

17. The driving circuit of claim 15, wherein a second cycle has a first period and a second period;
wherein in the normal operation mode, during the first period of the second cycle, the voltage at the first output terminal is of the second voltage level and the voltage at the second output terminal is of the first voltage level, and during the second period of the second cycle, the voltage at the first output terminal and the voltage at the second output terminal are of the second voltage level;
wherein in the power loss mode, during the first period of the second cycle, the voltage at the first output terminal is of the first voltage level and the voltage at the second output terminal is of the second voltage level, and during the second period of the second cycle, the voltage at the first output terminal and the voltage at the second output terminal are of the second voltage level.

18. The driving circuit of claim 17, wherein in the normal operation mode, during the first period of the second cycle, the second switch and the third switch are turned on, and during the second period of the second cycle, the second switch and the fourth switch are turned on;
wherein in the power loss mode, during the first period of the second cycle, the first switch and the fourth switch are turned on, during the second period of the second cycle, the second switch and the fourth switch are turned on.

19. The driving circuit of claim 15, wherein the switching circuit further comprises:
a fifth switch and a sixth switch coupled in series; and
a third output terminal coupled to the fifth switch, the sixth switch, and a third terminal of the motor;
wherein the driving control circuit is further configured to control the fifth switch and the sixth switch in response to the PWM signal;
wherein a second cycle has the first period and the second period;
wherein in the normal operation mode, during the first period of the second cycle, the voltage at the first output terminal is of the first voltage level and the voltage at the second output terminal and a voltage at the third output terminal are of the second voltage level, and during the second period of the second cycle, the voltage at the first output terminal, the voltage at the second output terminal, and the voltage at the third output terminal are of the second voltage level;
wherein in the power loss mode, during the first period of the second cycle, the voltage at the first output terminal and the voltage at the second output terminal are of the second voltage level and the voltage at the third output terminal is of the first voltage level, and during the second period of the second cycle, the voltage at the first output terminal, the voltage at the second output terminal, and the voltage at the third output terminal are of the second voltage level.

20. The driving circuit of claim 19, wherein in the normal operation mode, during the first period of the second cycle, the first switch and the sixth switch are turned on, and during the second period of the second cycle, the second switch and the sixth switch are turned on;
wherein in the power loss mode, during the first period of the second cycle, the second switch and the fifth switch are turned on, during the second period of the second cycle, the second switch and the sixth switch are turned on.
